(19) United States
(12) Patent Application Publication
(10) Pub. No.: US 2026/0091613 A1
(43) Pub. Date: Apr. 2, 2026

(54) REMOVABLY ATTACHABLE NOTECARD SLEEVE DEVICE

(71) Applicant: Karrie Gaudette, Traverse City, MI (US)

(72) Inventor: Karrie Gaudette, Traverse City, MI (US)

(21) Appl. No.: 18/904,793

(22) Filed: Oct. 2, 2024

(51) Int. Cl. B42F 1/00; B42F 21/06; G09F 1/10

(52) U.S. Cl. CPC B42F 1/006; B42F 21/06; G09F 1/103

(57) ABSTRACT

A removably attachable notecard sleeve device for binding and identifying a stack of papers includes a panel and a binder clip. The panel has an upper and lower edges, opposed lateral edges and front and rear faces. The front face of the panel can receive indicia to identify a stack of papers. The binder clip is attached to the rear face of the panel adjacent to the upper edge of the panel. The binder clip is biased to a closed configuration and is selectively openable to an open configuration. The stack of papers can be inserted into the binder clip when in the open configuration and the binder clip in the closed configuration retain the stack of papers with the indicia being visible to a user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to notecard sleeve devices and more particularly pertains to a new notecard sleeve device for binding and identifying a stack of papers. It often is desirable to collect related loose papers and/or related documents into a single stack and bind them in a temporary manner. A device that accomplishes this while enabling the user to concurrently label the stack of papers with identifying information would be beneficial.

### (2) Description of Related Art Including Information Disclosed Under 37 CFR 1.97 and 1.98

The prior art relates to notecard sleeve devices, which may comprise binder clips to which indicia are attachable, note sleeves to which binder clips are attachable, but not along their upper edges, and tabs attachable to binder clips such that the tabs protrude from stacks of paper bound by the binder clips. Prior art notecard sleeve devices lack a panel having a binder clip attached to its rear face and having a front face configured for bearing indicia for identifying a stack of papers to which the notecard sleeve device is attached.

### BRIEF SUMMARY OF THE INVENTION

An embodiment of the disclosure meets the needs presented above by generally comprising a panel and a binder clip. The panel has an upper edge, a lower edge, opposed lateral edges, a front face, and a rear face. The front face of the panel is configured to receive indicia to identify a stack of papers. The binder clip is attached to the rear face of the panel adjacent to the upper edge of the panel. The binder clip is biased to a closed configuration and is selectively openable to an open configuration. The binder clip in the open configuration is configured for insertion of the stack of papers. The binder clip in the closed configuration is configured to retain the stack of papers with the indicia being visible to a user.

Another embodiment of the disclosure includes a removably attachable notecard sleeve system comprises the removably attachable notecard sleeve device, as per the disclosure above, a stack of papers, and indicia. The stack of papers is bound by the binder clip of the removably attachable notecard sleeve device with the binder clip being in the closed configuration. The indicia are positioned on the front face of the panel and identify the stack of papers.

Yet another embodiment of the disclosure includes a method of binding and identifying a stack of papers. The method entails provision of a removably attachable notecard sleeve device, according to the disclosure above. Additional steps of the method is affixing the indicia to the front face of the panel and using the binder clip to bind a stack of papers that require binding and identification so that the indicia are visible to the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear isometric perspective view of a removably attachable notecard sleeve device according to an embodiment of the disclosure.

FIG. 2 is a front isometric perspective view of an embodiment of the disclosure.

FIG. 3 is a side view of an embodiment of the disclosure.

FIG. 4 is an in-use view of an embodiment of the disclosure.

FIG. 5 is an in-use view of an embodiment of the disclosure.

FIG. 6 is an in-use system view of an embodiment of the disclosure.

FIG. 7 is a flow diagram for a method utilizing an embodiment of the disclosure.

### DETAILED DESCRIPTION OF THE INVENTION

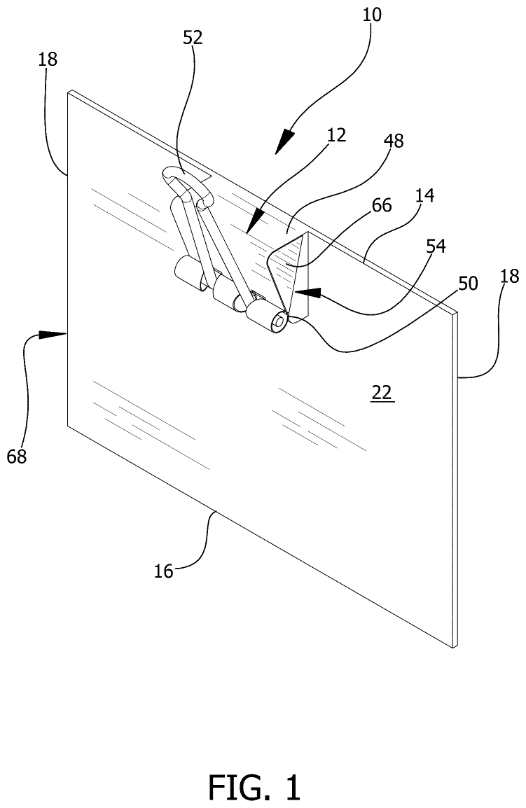

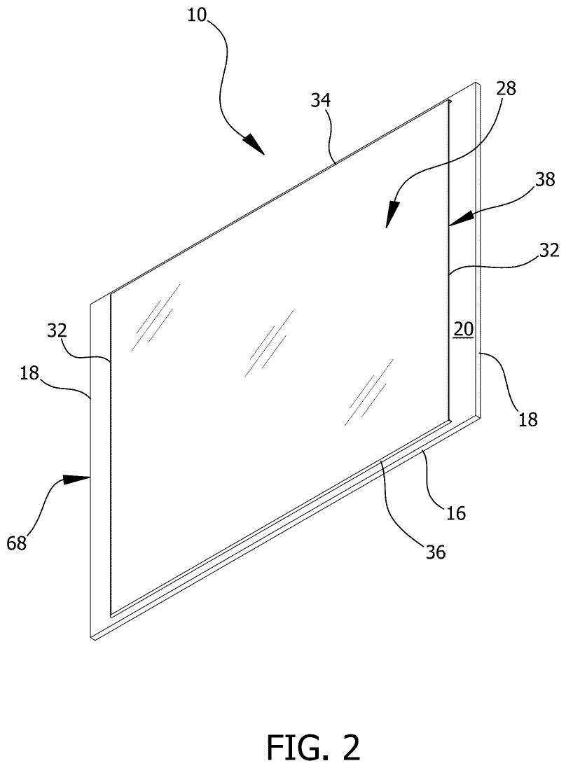

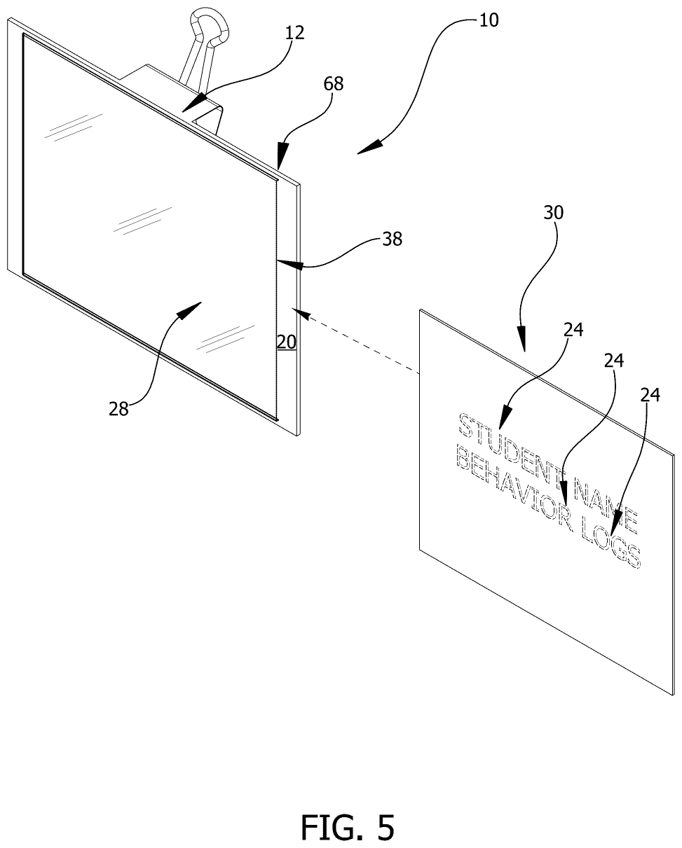

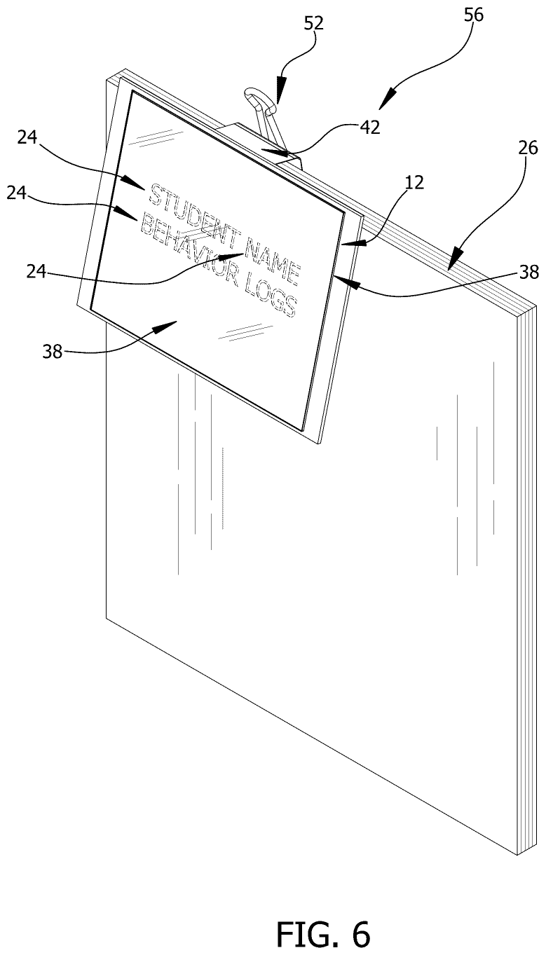

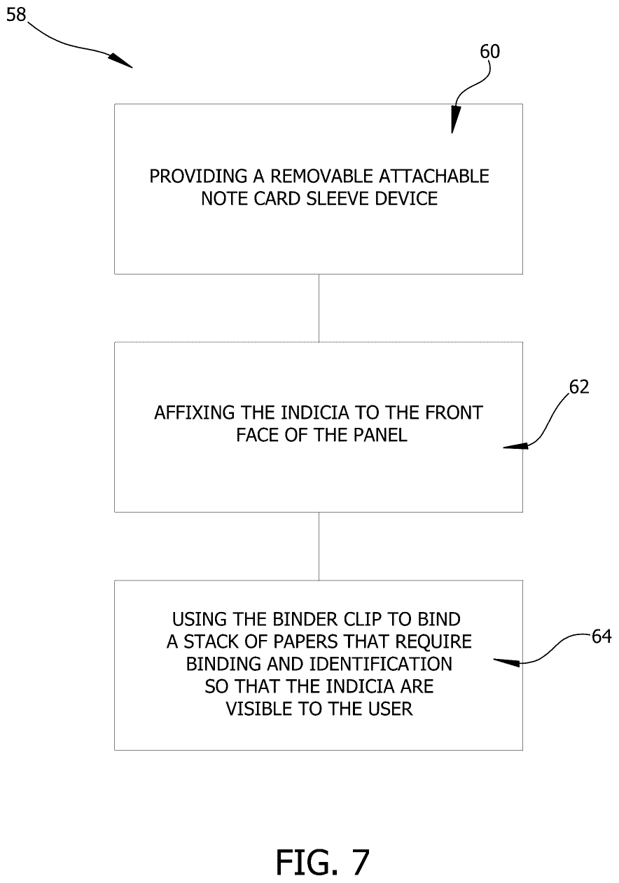

With reference now to the drawings, and in particular to FIGS. 1 through 7 thereof, a new notecard sleeve device embodying the principles and concepts of an embodiment of the disclosure and generally designated by the reference numeral 10 will be described.

As best illustrated in FIGS. 1 through 7, the removably attachable notecard sleeve device 10 generally comprises a panel 68 and a binder clip 12. The panel 68 has an upper edge 14, a lower edge 16, opposed lateral edges 18, a front face 20, and a rear face 22. The front face 20 of the panel 68 is configured to receive indicia 24 to identify a stack of papers 26. For example, the front face 20 may be configured such that a user can write upon it using pens, pencils, chalk, markers, dry-erase markers, or the like. The front face 20 also may be configured for attachment of adhesive labels, magnetic labels, or the like. Additionally, the panel 68 may be fitted with a sleeve 28 into which a notecard 30 is insertable, as is discussed further below. The panel 68 generally will be rectangularly shaped, as is shown in the figures, and would be rigid or semirigid by means of comprising card stock, plastic, wood, metal, or the like.

The removably attachable notecard sleeve device 10 may comprise the sleeve 28, which is attached to the front face 20 of the panel 68. The sleeve 28 is substantially transparent and has opposing edges 32, an upper limit 34, and a lower limit 36. The sleeve 28 typically will comprise clear plastic. A slit 38 is positioned in a respective opposing edge 32 of the sleeve 28 and extends from proximate to the upper limit 34 to proximate to the lower limit 36 of the sleeve 28. The notecard 30 either bears or is configured to receive the indicia 24. The notecard 30 is selectively insertable through the slit 38 into the sleeve 28 so that the indicia 24 are visible through the sleeve 28.

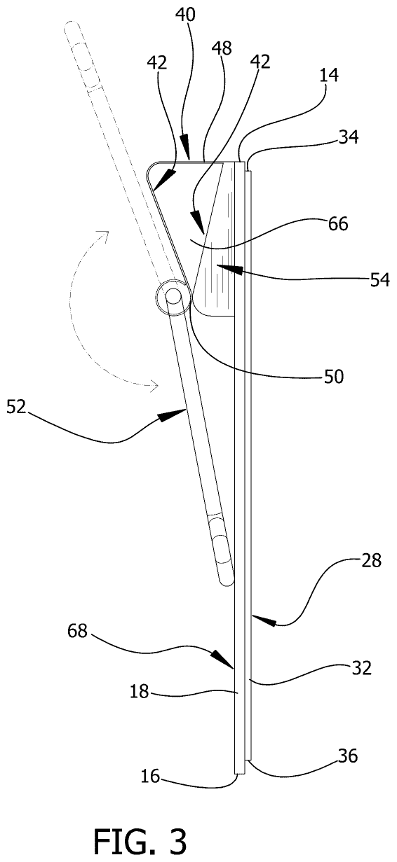

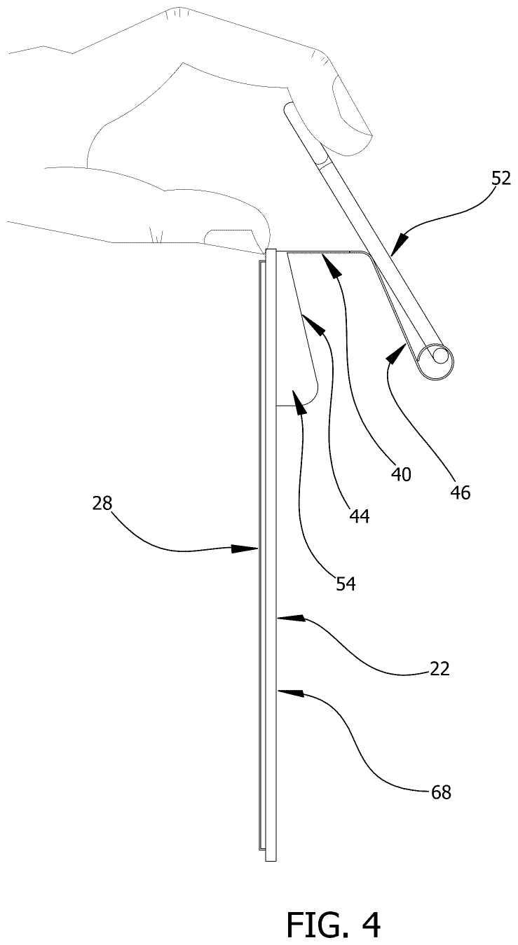

The binder clip 12 is attached to the rear face 22 of the panel 68 adjacent to the upper edge 14 of the panel 68. The binder clip 12 is biased to a closed configuration, as is shown in FIGS. 1 and 3, and is selectively openable to an open configuration, as is shown in FIG. 4. The binder clip 12 in the open configuration is configured for insertion of the stack of papers 26. The binder clip 12 in the closed configuration is configured to retain the stack of papers 26 with the indicia 24 being visible to the user.

Such binder clips 12 are well known to those skilled in the art of binders for stacks of papers 26. As is shown in the figures, the binder clip 12 comprises a strip of spring steel 40 that forms a pair of jaws 42. The pair of jaws 42 comprises a fixed jaw 44, which is attached to the panel 68, and a movable jaw 46. The pair of jaws 42 has an upper end 48, a lower end 50, and a substantially isosceles triangle shaped cross-sectional profile 66, as is shown in FIG. 3. The jaws 42 are biased to the closed configuration, as is shown in FIG. 3. The movable jaw 46 is pivotable relative to the fixed jaw 44 to position the binder clip 12 in the open configuration, as is shown in FIG. 4.

A handle 52 is attached to the movable jaw 46 proximate to the lower end 50 of the pair of jaws 42. The handle 52 is dimensionally longer than the movable jaw 46 such the handle 52 extends beyond the upper end 48 of the pair of jaws 42, thereby positioning the handle 52 in an operable position, as is shown in FIG. 4. The handle 52 and the panel 68 are configured to be pinched between digits of a hand of the user to move the binder clip 12 from the closed configuration to the open configuration, as is shown in FIGS. 3 and 4, respectively. The handle 52 is hingedly attached to the movable jaw 46 so that the handle 52 is reversibly positionable in the operable configuration and a stowed configuration, wherein handle 52 extends away from the lower end 50 of the pair of jaws 42, as is shown in FIG. 3.

As is shown in FIGS. 3 and 4, a wedge 54 is attached to and extends between the panel 68 and the fixed jaw 44. The upper end 48 of the pair of jaws 42 thus is substantially perpendicular to the panel 68 and the lower end 50 of the pair of jaws 42 is spaced from the rear face 22 of the panel 68. The lower end 50 being spaced from the rear face 22 facilitates binding of the stack of papers 26.

The present invention also anticipates a removably attachable notecard sleeve system 56, which comprises the removably attachable notecard sleeve device 10, as per the specification above, a stack of papers 26, and indicia 24. The stack of papers 26 is bound by the binder clip 12 of the removably attachable notecard sleeve device 10 with the binder clip 12 being in the closed configuration. The indicia 24 are positioned on the front face 20 of the panel 68 and identify the stack of papers 26.

The removably attachable notecard sleeve device 10 enables a method of binding and identifying a stack of papers 58. The method 58 comprises a first step 60 of providing a removably attachable notecard 30 sleeve 28 device, according to the specification above. A second step 62 of the method 58 is affixing the indicia 24 to the front face 20 of the panel 68. A third step 64 of the method 58 is using the binder clip 12 to bind a stack of papers 26 that require binding and identification so that the indicia 24 are visible to the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A removably attachable notecard sleeve device comprising:
a panel having an upper edge, a lower edge, opposed lateral edges, a front face, and a rear face, the front face of the panel being configured for receiving indicia for identifying a stack of papers; and
a binder clip being attached to the rear face of the panel adjacent to the upper edge of the panel, the binder clip being biased to a closed configuration and being selectively openable to an open configuration, wherein the binder clip in the open configuration is configured for insertion of the stack of papers and wherein the binder clip in the closed configuration is configured for retaining the stack of papers with the indicia being visible to a user.

2. The removably attachable notecard sleeve device of claim 1, further comprising:
a sleeve being attached to the front face of the panel, the sleeve being substantially transparent and having opposing edges, an upper limit, and a lower limit;
a slit being positioned in a respective opposing edge of the sleeve and extending from proximate to the upper limit to proximate to the lower limit of the sleeve; and
a notecard bearing or configured for receiving the indicia, the notecard being selectively insertable through the slit into the sleeve such that the indicia are visible through the sleeve.

3. The removably attachable notecard sleeve device of claim 1, wherein the binder clip comprises:
a strip of spring steel forming a pair of jaws, the pair of jaws comprising a fixed jaw and a movable jaw, the fixed jaw being attached to the panel, the pair of jaws having an upper end, a lower end, and a substantially isosceles triangle shaped cross-sectional profile, the jaws of the pair of jaws being biased to the closed configuration, the movable jaw being pivotable relative to the fixed jaw to position the binder clip in the open configuration; and
a handle being attached to the movable jaw proximate to the lower end of the pair of jaws, the handle being dimensionally longer than the movable jaw such the handle extends beyond the upper end of the pair of jaws, thereby positioning the handle in an operable position, wherein the handle and the panel are configured for being pinched between digits of a hand of the user for moving the binder clip from the closed configuration to the open configuration.

4. The removably attachable notecard sleeve device of claim 3, wherein the handle is hingedly attached to the movable jaw such that the handle is reversibly positionable in the operable configuration and a stowed configuration, wherein the handle extends away from the lower end of the pair of jaws.

5. The removably attachable notecard sleeve device of claim 3, further comprising a wedge, the wedge being attached to and extending between the panel and the fixed jaw, such that the upper end of the pair of jaws is substantially perpendicular to the panel and such that the lower end of the pair of jaws is spaced from the rear face of the panel.

6. The removably attachable notecard sleeve device of claim 1, further comprising:
a sleeve being attached to the front face of the panel, the sleeve being substantially transparent and having opposing edges, an upper limit, and a lower limit;
a slit being positioned in a respective opposing edge of the sleeve and extending from proximate to the upper limit to proximate to the lower limit of the sleeve;
a notecard bearing or configured for receiving the indicia, the notecard being selectively insertable through the slit into the sleeve such that the indicia are visible through the sleeve;
the binder clip comprising:
a strip of spring steel forming a pair of jaws, the pair of jaws comprising a fixed jaw and a movable jaw, the fixed jaw being attached to the panel, the pair of jaws having an upper end, a lower end, and a substantially isosceles triangle shaped cross-sectional profile, the jaws of the pair of jaws being biased to the closed configuration, the movable jaw being pivotable relative to the fixed jaw to position the binder clip in the open configuration; and
a handle being attached to the movable jaw proximate to the lower end of the pair of jaws, the handle being dimensionally longer than the movable jaw such the handle extends beyond the upper end of the pair of jaws, thereby positioning the handle in an operable position, wherein the handle and the panel are configured for being pinched between digits of a hand of the user for moving the binder clip from the closed configuration to the open configuration, the handle being hingedly attached to the movable jaw such that the handle is reversibly positionable in the operable configuration and a stowed configuration, wherein the handle extends away from the lower end of the pair of jaws; and
a wedge being attached to and extending between the panel and the fixed jaw, such that the upper end of the pair of jaws is substantially perpendicular to the panel and such that the lower end of the pair of jaws is spaced from the rear face of the panel.

7. A removably attachable notecard sleeve system comprising:
a panel having an upper edge, a lower edge, opposed lateral edges, a front face, and a rear face;
a binder clip being attached to the rear face of the panel adjacent to the upper edge of the panel, the binder clip being biased to a closed configuration and being selectively openable to an open configuration;
a stack of papers being bound by binder clip in the closed configuration; and
indicia being positioned on the front face of the panel and identifying the stack of papers.

8. A method of binding and identifying a stack of papers, the method comprising the steps of:
providing a removably attachable notecard sleeve device comprising:
a panel having an upper edge, a lower edge, opposed lateral edges, a front face, and a rear face, the front face of the panel being positioned for receiving indicia for identifying a stack of papers; and
a binder clip being attached to the rear face of the panel adjacent to the upper edge of the panel, the binder clip being biased to a closed configuration and being selectively openable to an open configuration, wherein the binder clip in the open configuration is configured for insertion of the stack of papers and wherein the binder clip in the closed configuration is configured for retaining the stack of papers with the indicia being visible to a user;
affixing the indicia to the front face of the panel; and
using the binder clip to bind a stack of papers requiring binding and identification such that the indicia are visible to the user.
